(19) United States
(12) Patent Application Publication
(10) Pub. No.: US 2025/0333625 A1
(43) Pub. Date: Oct. 30, 2025

(54) Hot Melt Adhesive Film

(71) Applicant: CHANCE LINE INDUSTRIAL CO., LTD., Siansi Township (TW)

(72) Inventor: Ming-Hsien YAO, Siansi Township (TW)

(21) Appl. No.: 19/182,168

(22) Filed: Apr. 17, 2025

(30) Foreign Application Priority Data
Apr. 24, 2024 (TW) 113115331

(51) Int. Cl. C09J 7/35; C09J 7/29

(52) U.S. Cl. CPC C09J 7/35; C09J 7/29; C09J 2203/358; C09J 2301/208; C09J 2301/304

(57) ABSTRACT

The invention relates to a hot melt adhesive film comprising a positioning layer, a glutinous layer and a hot melt glue layer. The hot melt glue layer is bonded to the positioning layer by the glutinous layer. The hot melt glue layer can be used to cut out graphics, and the cut-out graphics can be positioned on the positioning layer.

### FIELD OF THE INVENTION

The invention relates to a hot melt adhesive film, more particularly to a hot melt adhesive film which can be used to heat press fine graphics on an object.

### DESCRIPTION OF THE RELATED ART

Many consumers design graphics and stick them on their clothes to make the clothes unique. Existing self-adhesive flannel is an item that enables consumers to cut out graphics and stick them on clothing.

Self-adhesive flannel is formed by setting adhesive on flannel or planting fluff on hot melt adhesive. After consumers cut out graphics from the self-adhesive flannel, the adhesive or hot melt adhesive of the self-adhesive flannel is used to stick the graphics on clothes, and the surface of the clothes will have graphics made of fluff material.

Although self-adhesive flannel enables consumers to cut out graphics and stick them on clothes, it has been found through use that graphics made from self-adhesive flannel have various drawbacks and need to be improved.

Firstly, since the fluff of the self-adhesive flannel is fiber and is not easy to cut, it is difficult for consumers to cut out graphics with fine lines on the self-adhesive flannel. Secondly, the cut-out graphics are easily warped and difficult to stick smoothly and evenly on a surface of an object. Thirdly, if the cut-out graphic has at least two separated and unconnected parts, it is difficult to accurately control the spacing and positions between the two parts when the two parts are glued to the clothes. During the gluing process, any part may be skewed, and the spacings between multiple parts may be incorrect, such as too close or too far, resulting in the glued graphic being unaesthetic and greatly reducing the effect of pasting the graphic on clothes.

Other items that can be used to cut out graphics and paste them on clothes comprise self-adhesive light reflective film and self-adhesive bronzing film. After cutting out the graphic from the light reflective film and bronzing film, the graphic is pasted on clothes with the adhesive. Similarly, since light reflective film uses micro glass beads as light reflective elements, the granular micro glass beads make it difficult for consumers to cut out fine-line graphics on the light reflective film. The bronzing elements on the bronzing film also make it difficult for consumers to cut out detailed graphics on the bronzing film. When consumers paste the graphics cut-out from the light reflective film or bronzing film on clothes, it is easy for the graphics to be pasted skewedly or the spacings between several parts of the graphics to be incorrect.

### SUMMARY OF THE INVENTION

A main object of the invention is to provide a hot melt adhesive film to enable users, especially end consumers, using the hot melt adhesive film to heat press and form fine-line graphics on a surface of an object.

Another object of the invention is to provide a hot melt adhesive film capable of cutting out graphics with fine lines and fine contours and keeping the graphics in the correct position.

Yet another object of the invention is to provide a hot melt adhesive film capable of facilitating smooth, flat and even adhesion of graphics on objects.

A hot melt adhesive film provided by the invention comprises:
a positioning layer;
a glutinous layer; and
a hot melt glue layer made of a hot melt adhesive material and adhered to the positioning layer through the glutinous layer; an adhesion force between the hot melt glue layer and the glutinous layer is smaller than an adhesion force between the positioning layer and the glutinous layer.

Thus, end consumers can cut out a fine graphic from the hot melt glue layer of the hot melt adhesive film, and the hot melt glue layer forming the graphic is positioned on the positioning layer to maintain smoothness, flatness and integrity of the graphic and to position each part of the graphic in correct positions. The hot melt glue layer forming the graphic is heat pressed on a surface of an object, and a transfer material is heat pressed and adhered on the hot melt glue layer, so that a fine pattern can be formed on the surface of the object.

Preferably, the hot melt glue layer is in a form of at least one layer of hot melt adhesive.

Preferably, the hot melt glue layer has a first glue layer and a second glue layer disposed as upper and lower layers, when in use, the first glue layer is used to adhere to a surface of an object, and the second glue layer is used to adhere to the transfer material.

Preferably, the first glue layer and the second glue layer can be hot melt adhesives of a same material or different materials. Different materials of the first glue layer and the second glue layer can be selected according to material characteristics of a heat pressed object and the transfer material.

Preferably, the hot melt glue layer has a first glue layer, a second glue layer and an isolation layer, the isolation layer is disposed between the first glue layer and the second glue layer to separate the first glue layer from the second glue layer to control an adhesion of the two glue layers.

Preferably, the glutinous layer has release properties.

Preferably, the positioning layer is a plastic film or a paper.

Preferably, a melting point of the position layer is higher than a melting point of the hot melt glue layer.

Preferably, a melting point of the isolation layer is higher than the melting points of the first glue layer and the second glue layer.

Preferably, a material of the positioning layer is polyethylene terephthalate (PET), polyvinyl chloride (PVC) or polypropylene (PP).

Preferably, a material of the hot melt adhesive of the hot melt glue layer is polyolefin (PO), polyurethane (PU), thermoplastic polyurethane (TPU), polyamide (PA), polyether sulfone (PES), polyethylene (PE), ethylene vinyl acetate (EVA) or rubber based material (thermoplastic rubber (TPR)/rubber).

### BRIEF DESCRIPTION OF DRAWINGS

The objects, features, and achieved efficacies of the invention can be understood from the description and drawings of the following preferred embodiments, in which:

FIG. 1 is a cross-sectional view of a hot melt adhesive film according to a first preferred embodiment of the invention.

FIG. 2 to FIG. 13 show a process of using the hot melt adhesive film of the invention to form fine graphics on a surface of an object by heat pressing.

FIG. 2 is a front view of the hot melt adhesive film of the first preferred embodiment of the invention, and shows a graphic cut out from a hot melt glue layer of the hot melt adhesive film.

FIG. 3 is a cross-sectional view taken along section line 3-3 of FIG. 2.

FIG. 4 is similar to FIG. 3, showing the hot melt adhesive film and the hot melt glue layer after waste materials of the hot melt glue layer are removed.

FIG. 5 is a cross-sectional view showing the hot melt glue layer with a cut-out graphic in FIG. 4 being heat pressed on an object.

FIG. 6 shows a front view of the hot melt glue layer of FIG. 5 being heat pressed and adhered to an object, a positioning layer and a glutinous layer of the hot melt adhesive film have been removed.

FIG. 7 is a cross-sectional view taken along section line 7-7 of FIG. 6.

FIG. 8 is a schematic diagram showing that a transfer sheet is placed on the object of FIG. 6.

FIG. 9 is a cross-sectional view taken along section line 9-9 of FIG. 8.

FIG. 10 is a diagram showing an operation of tearing off the transfer sheet from the object.

FIG. 11 is a perspective view of the completed graphic, a surface of the graphic has a transfer material.

FIG. 12 is a cross-sectional view taken along section line 12-12 of FIG. 11.

FIG. 13 is similar to FIG. 12, showing another transfer material combined on a graphic.

FIG. 14 is similar to FIG. 2, showing an embodiment of cutting out another graphic from the hot melt glue layer of the hot melt adhesive film.

FIG. 15 is a schematic diagram showing a graphic formed by the hot melt glue layer of FIG. 14 being heat pressed and adhered to a surface of an object.

FIG. 16 is a cross-sectional view of the hot melt adhesive film according to a second preferred embodiment of the invention.

FIG. 17 is a cross-sectional view showing the hot melt glue layer of the hot melt adhesive film of FIG. 16 being heat pressed on a surface of an object after a graphic is cut out from the hot melt adhesive film.

FIG. 18 is a cross-sectional view showing the hot melt glue layer of FIG. 17 being heat pressed on a surface of an object.

FIG. 19 is a cross-sectional view of the completed graphic, a surface of the graphic has a transfer material.

### DETAILED DESCRIPTION OF THE INVENTION

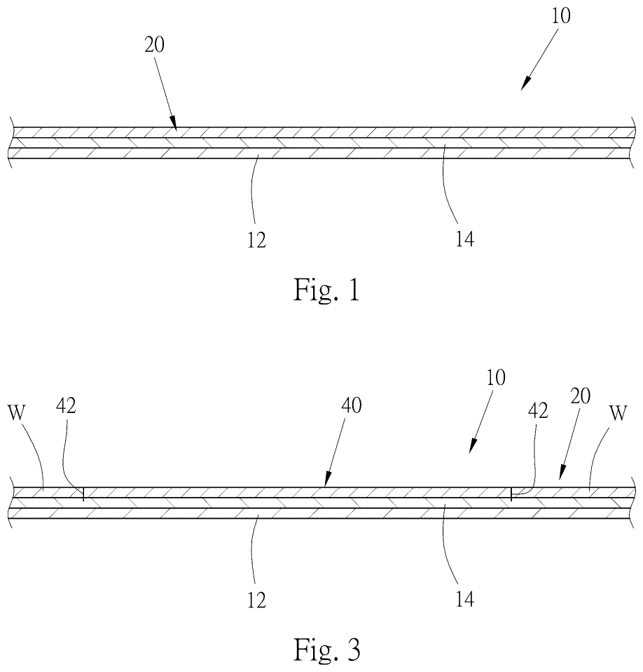

Please refer to FIG. 1, which is a cross-sectional view of a hot melt adhesive film 10 provided in a first preferred embodiment of the invention. The hot melt adhesive film 10 is a thin sheet-like object, comprising: a positioning layer 12, a glutinous layer 14 and a hot melt glue layer 20, and the hot melt glue layer 20 is adhered onto the positioning layer 12 by the glutinous layer 14.

The hot melt glue layer 20 is a layer of hot melt adhesive material, and can be formed by various types of hot melt adhesives, for example, but are not limited to, hot melt adhesives of materials such as polyolefin (PO), polyurethane (PU), thermoplastic polyurethane (TPU), polyamide (PA), polyether sulfone (PES), polyethylene (PE), ethylene vinyl acetate (EVA) and rubber based material (thermoplastic rubber (TPR)/rubber). When a hot melt adhesive is heated to a certain temperature, it melts into a fluid adhesive, and becomes solid after cooling, with a fast bonding speed. In this embodiment, the hot melt glue layer 20 is a single layer of hot melt adhesive.

The positioning layer 12 is a layer for the hot melt glue layer 20 to adhere to and position, and can be made of paper or plastic material, with a melting point higher than that of the hot melt adhesive. The positioning layer 12 can be made of polyethylene terephthalate (PET), polyvinyl chloride (PVC) or polypropylene (PP), but is not limited thereto.

The glutinous layer 14 is made of a releasable adhesive material and will not adhere permanently to the hot melt glue layer 20. The hot melt glue layer 20 can be easily separated from the glutinous layer 14, and the hot melt glue layer 20 is temporarily adhered onto the positioning layer 12 by the glutinous layer 14. An adhesion force between the positioning layer 12 and the glutinous layer 14 is greater than an adhesion force between the hot melt glue layer 20 and the glutinous layer 14. When the hot melt glue layer 20 is separated from the positioning layer 12, the glutinous layer 14 is still attached on the positioning layer 12 and will not be attached on the hot melt glue layer 20.

The hot melt adhesive film 10 of the invention is convenient for end consumers or businesses to use. The hot melt adhesive film 10 is used to heat press and form fine-line graphics on a surface of an object. The object is a variety of objects with surfaces capable of adhering to hot melt adhesive, such as fabric, clothes, paper, daily necessities, furniture, electrical appliances, indoor and outdoor boxes, shells. As long as the surface of the object can be adhered to by hot melt adhesive, a material of the object is not limited, and it can be metal, plastic, wood, ceramic etc.

The following describes a process of consumers or businesses using the hot melt adhesive film 10 as a medium to heat press and form graphics of fluff material, micro glass beads, bronzing material or glitter on a surface of an object. The following description will be made by heat pressing and transferring fluff planted on a flannel onto a surface of an object as an example.

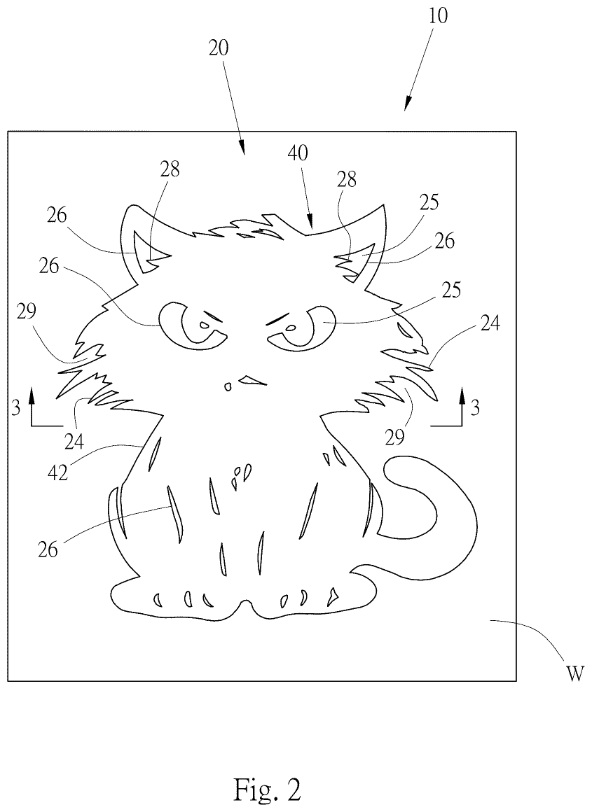

Please refer to FIGS. 2 and 3. Consumers or users cut out a graphic 40 from the hot melt glue layer 20 of the hot melt adhesive film 10. The graphic 40 can be cut out manually or using a computer-controlled cutting device. A cutting depth of the graphic 40 cuts through the hot melt glue layer 20. FIG. 2 shows that a cut mark 42 of the graphic 40 cuts through/cuts off the hot melt glue layer 20. The graphic 40 can be words, symbols, various patterns or a combination thereof, and consumers can freely design and cut out the desired graphic. The graphic 40 of this embodiment takes a cat as an example. It should be noted that, at this time, the graphic 40 cut out from the hot melt adhesive film 10 is a mirror image of a heat pressed graphic to be formed.

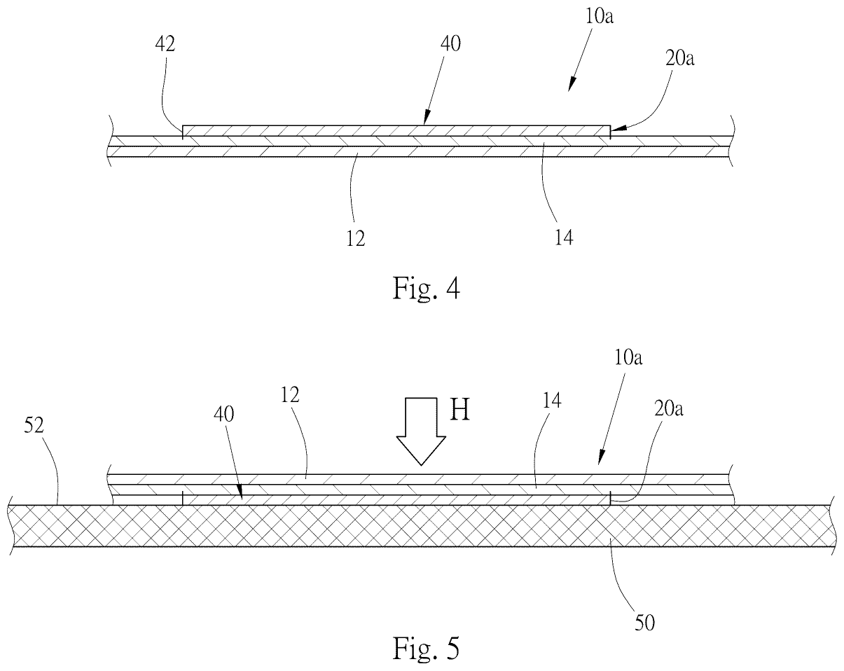

After the graphic 40 (mirror image) is cut, a waste material W not belonging to the graphic 40 is torn off from the hot melt glue layer 20 to form a hot melt adhesive film 10a and a hot melt glue layer 20a of FIG. 4. At this time, the hot melt glue layer 20a is a hot melt adhesive material forming the graphic 40 without the waste material W. The graphic 40 (the hot melt glue layer 20a) is positioned on the positioning layer 12 to ensure that each part of the graphic 40 is located at correct positions to facilitate subsequent heat pressing and transfer printing.

Then, as shown in FIG. 5, the hot melt glue layer 20a of the hot melt adhesive film 10a is brought into contact with a surface 52 of an object 50, and heat pressing (H) is applied so that the hot melt glue layer 20a constituting the graphic 40 adheres to the surface 52 of the object 50. The graphic 40 is positioned on the hot melt adhesive film 10a and will not bend, so the graphic 40 can be smoothly and evenly adhered to the surface 52 of the object 50. Consumers can use electric irons to perform heat pressing operations, while businesses can use heat pressing machines to perform heat pressing operations. A melting point of the positioning layer 12 is higher than that of the hot melt glue layer 20a. During the heat pressing process, the hot melt glue layer 20a is melted by heat to generate viscosity and adhere onto the object 50, while the positioning layer 12 is not melted. A heat pressing temperature is between 100˜160° C. and a heat pressing time is about 10˜20 seconds.

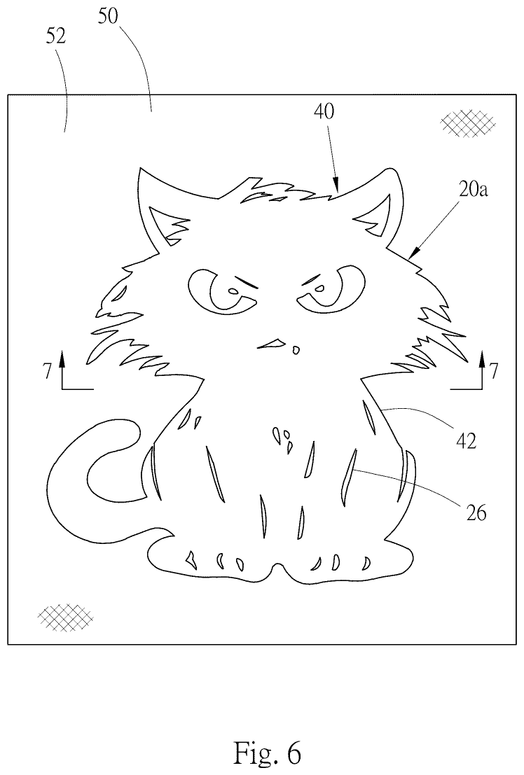

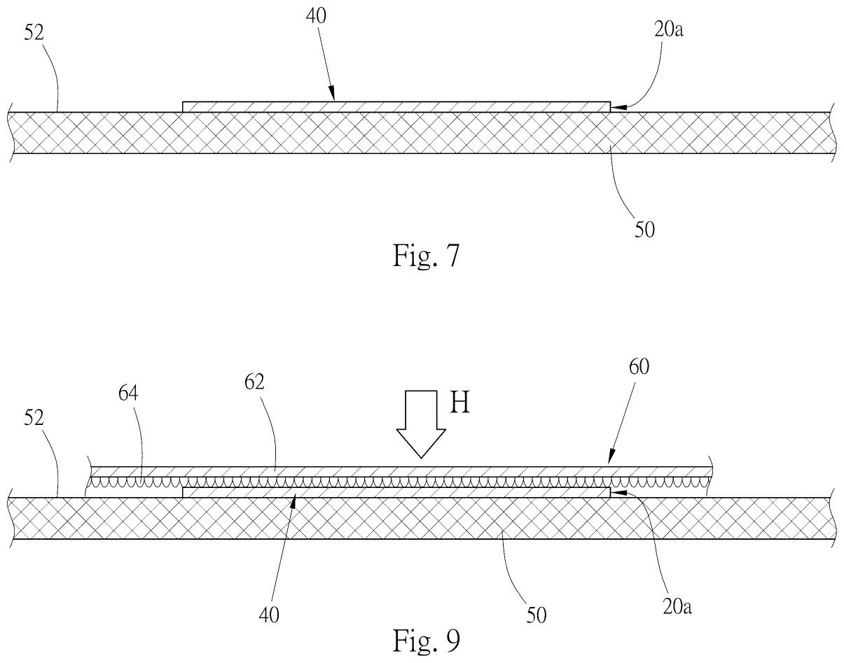

After heat pressing is completed, the positioning layer 12 is torn off to separate the positioning layer 12 from the hot melt glue layer 20a, and the glutinous layer 14 is separated from the hot melt glue layer 20a together with the positioning layer 12. The hot melt glue layer 20a (the graphic 40) is adhered to the surface 52 of the object 50 in a positioned state, as shown in FIG. 6 and FIG. 7. At this time, the graphic 40 is a positive image. When the graphic 40 is transferred from the hot melt adhesive film 10a to the surface 52 of the object 50, all parts thereof remain in correct positions without being skewed or offset, and original distances between the parts are maintained.

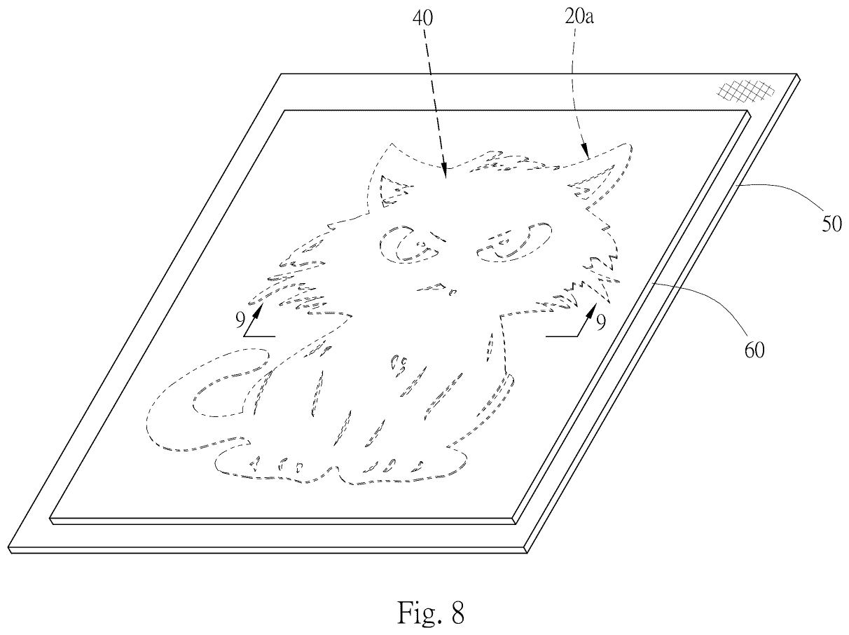

Please refer to FIGS. 8 and 9, a transfer sheet 60 is placed on the object 50 so that a transfer material 64 of the transfer sheet 60 contacts the hot melt glue layer 20a. The transfer sheet 60 has a carrier 62 on which the transfer material 64 is disposed. The transfer sheet 60 of this embodiment is a planted flannel as an example, and the transfer material 64 is fluff. The transfer sheet 60 and the hot melt glue layer 20a are subjected to heat pressing so that the transfer material (fluff) 64 on the transfer sheet 60 in contact with the hot melt glue layer 20a is adhered by the hot melt glue layer 20a.

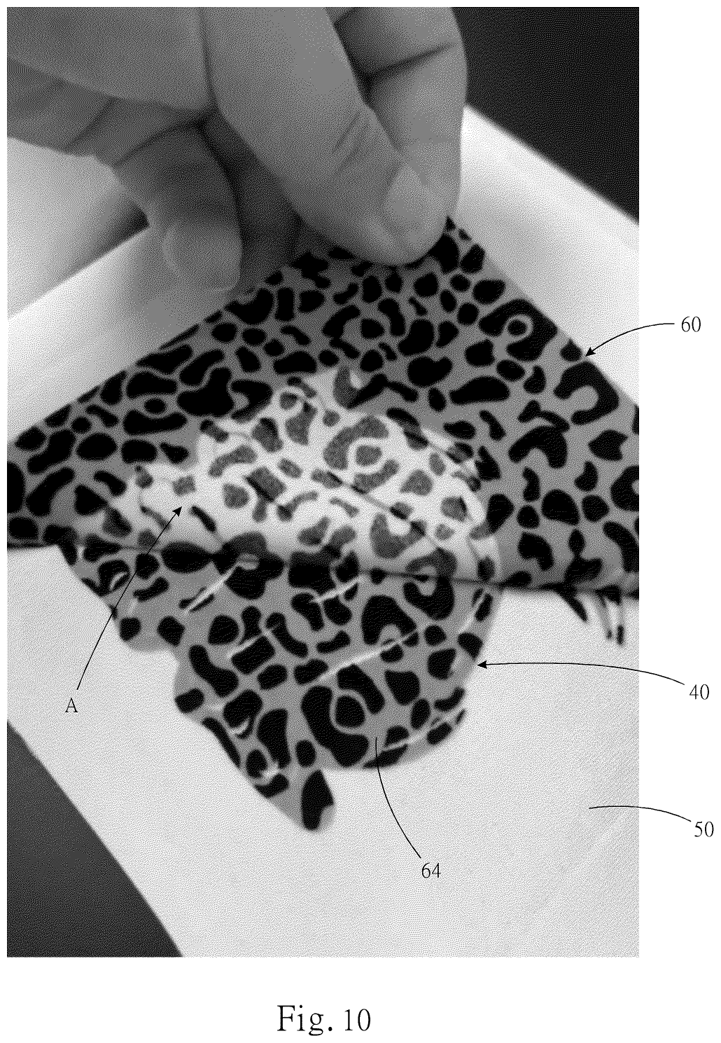

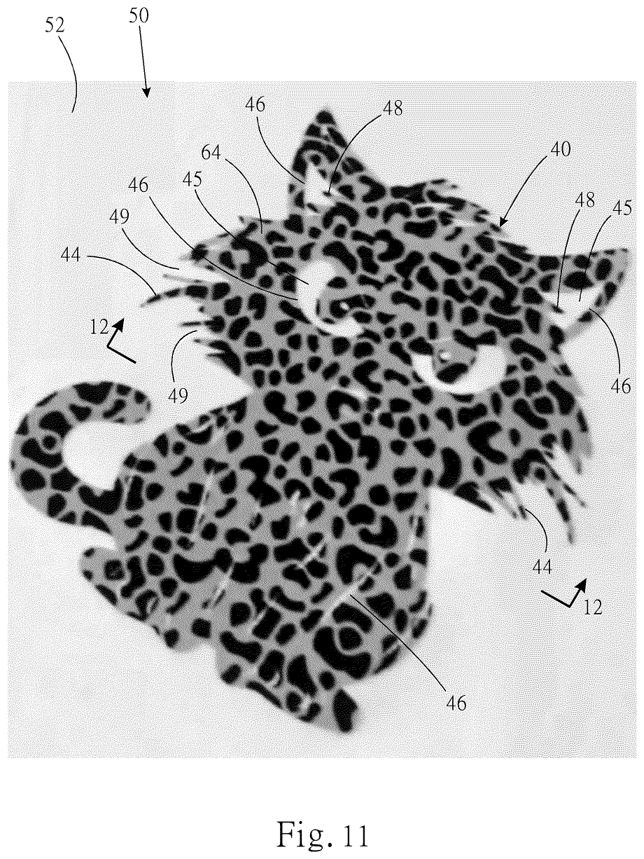

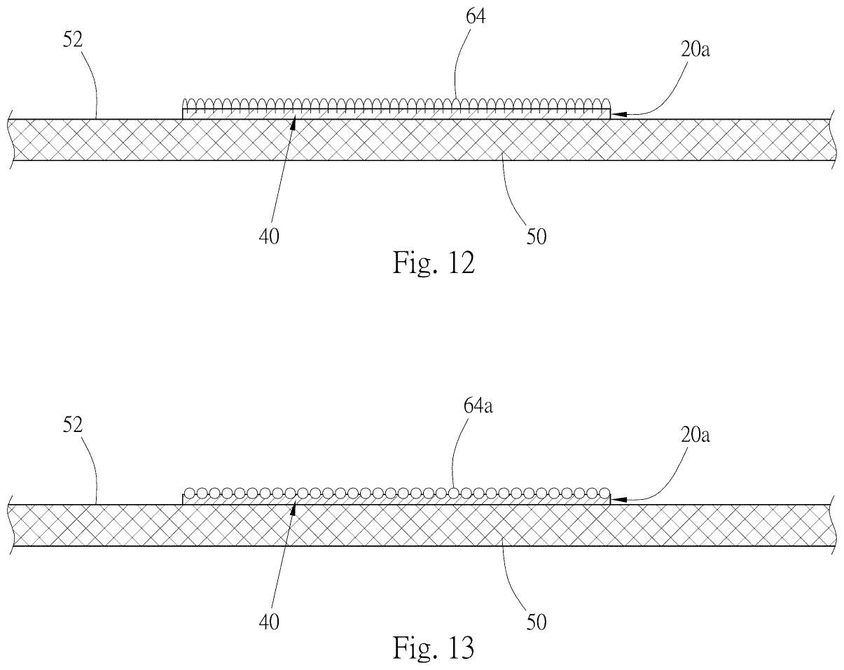

After the transfer material 64 is adhered to the hot melt glue layer 20a, the transfer sheet 60 is torn off, as shown in FIG. 10, and a finished product of the graphic 40 is completed by heat pressing and transfer printing. The transfer material 64 on the transfer sheet 60 that contacts the graphic 40 (the hot melt glue layer 20a), such as the transfer material 64 in an area indicated by label A in FIG. 10, is adhered on the graphic 40 and separated from the transfer sheet 60. The graphic 40 on the object 50 then has the transfer material (fluff) 64, as shown in FIGS. 11 and 12. The transfer material 64 that is not in contact with the hot melt glue layer 20a is still attached on the transfer sheet 60. The hot melt glue layer 20a constituting the graphic 40 is smoothly, flatly and evenly adhered to the surface 52 of the object 50, and the finished graphic 40 is smoothly, flatly and evenly formed on the surface 52 of the object 50, as shown in FIG. 11.

As shown in FIG. 2, it is easy to cut the hot melt adhesive film 10 of the invention, end consumers or businesses can cut out a fine graphic 40 from the hot melt glue layer 20. Periphery and interior of the hot melt glue layer 20 can be cut to form various fine and irregular lines 24, 26, 28, hollow portions 25, and various notches 29 located inside the graphic 40 or on a periphery of the graphic 40. Thus, as shown in FIG. 11, the graphic 40 cut out from the hot melt glue layer 20 can be heat pressed on the surface 52 of the object 50 to form the graphic 40 with a fine contour, and after the graphic 40 is made, a surface of the graphic 40 has the transfer material 64. By means of this manufacturing method, end consumers can make the graphic 40 with fine and delicate lines by DIY, such as, but not limited to, pointed lines 44 formed on a periphery of the graphic 40, hollow portions 45 formed in the graphic 40 and lines 46 of the hollow portions 45, pointed lines 48 in the hollow portions 45, lines of various irregular shapes, and various notches 49 inside the graphic 40 or on a periphery of the graphic 40. The hot melt adhesive of the invention can be used to form the graphic 40 with a fine shape and smooth lines, and fine parts of the graphic 40 are all provided with the transfer material 64. The conventional techniques described in the prior art are incapable of forming the fine lines 44, 46, 48, the hollow portions 45 and the notches 49 on graphics with fluff (transfer material), and incapable of forming graphics with complex contours and fine details.

In the graphic 40, a shape formed by the transfer material 64 is consistent with a shape cut out from the hot melt glue layer 20a. A shape of the transfer material 64 is formed by heat pressing and transfer printing, not by cutting.

FIGS. 11 and 12 show the graphic 40 having fluff. Please refer to FIG. 13. If the transfer sheet 60 is a light reflective film with micro glass beads, the transfer material 64 to which the graphic 40 is heat pressed and adhered is micro glass beads, so that the graphic 40 becomes a light reflective graphic. Similarly, if the transfer sheet 60 is a bronzing film, the transfer material 64 on the graphic 40 is a bronzing material made of metal, so that the graphic 40 becomes a bronzing graphic. If the transfer material 64 is luminous particles, the graphic 40 becomes a luminous graphic. If the transfer material 64 is a glitter material, the graphic 40 becomes a graphic with a glitter effect.

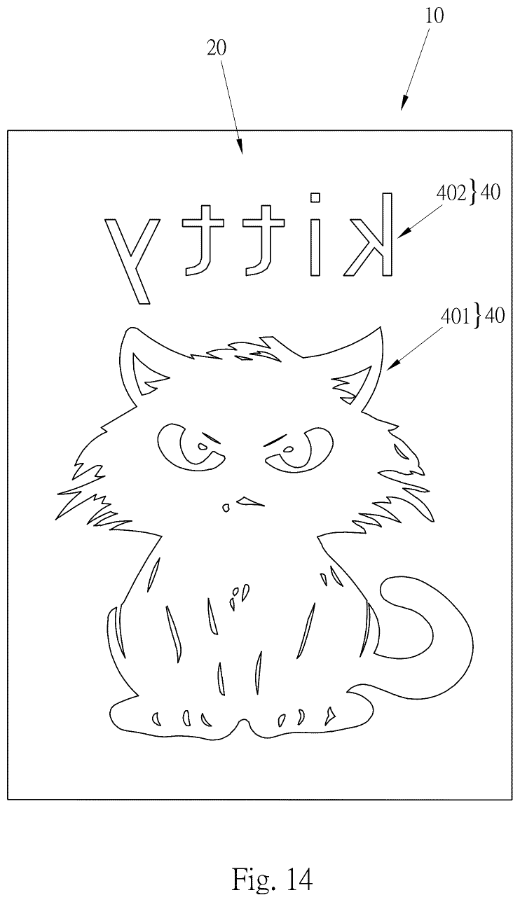

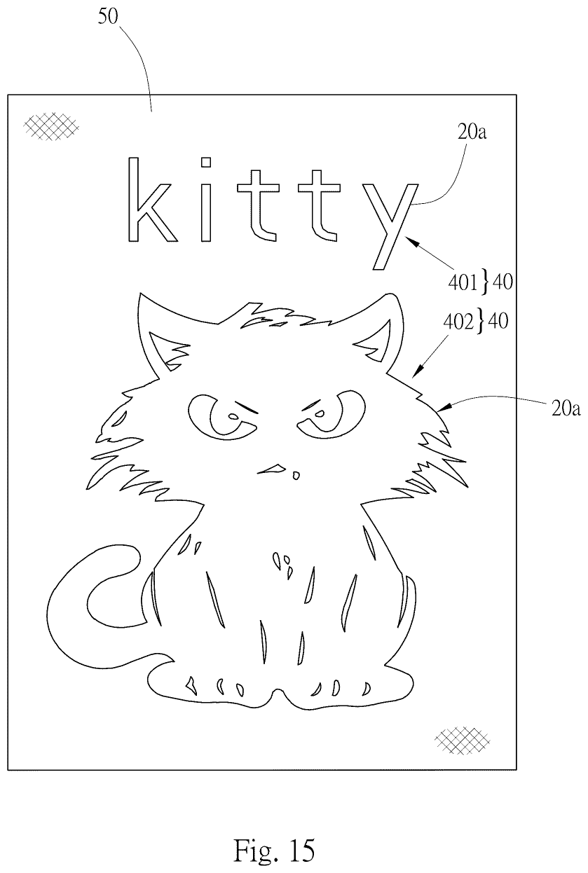

FIG. 14 shows another graphic 40 to be formed. The graphic 40 comprises a pattern (cat) 401 and a symbol or a word (kitty) 402. The graphic 401 and each English letter of the word 402 are separated from one another and not connected. When using the invention, the hot melt glue layer 20a used for cutting out the graphic 40 is adhered on the positioning layer 12, so that the graphic 401 and the word 402 are positioned on the positioning layer 12 to maintain integrity, smoothness and flatness of the graphic 40 and to place each of the parts 401, 402 of the graphic 40 in correct positions. When the graphic 40 is heat pressed to combine onto the object 50 from the hot melt adhesive film 10, as shown in FIG. 15, spacings and relative positions between the graphic 401 and the word 402 on the object 50 are maintained, and relative positions between the graphic 40 and the word 402 do not change, so there will be no problem of any part of the graphic 40 being skewed or spacings between the different parts of the graphic 40 being inappropriate.

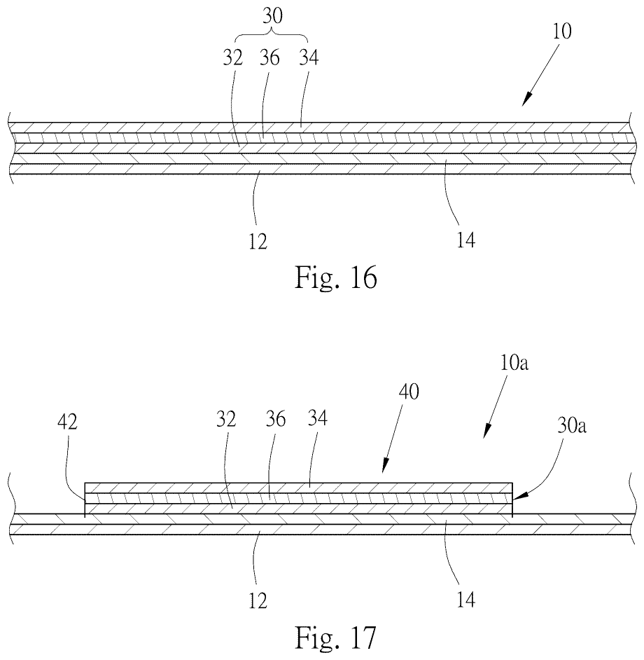

FIG. 16 is a cross-sectional view of the hot melt adhesive film 10 according to a second preferred embodiment of the invention, comprising a positioning layer 12, a glutinous layer 14 and a hot melt glue layer 30, the hot melt glue layer 30 is temporarily adhered on the positioning layer 12 by the glutinous layer 14.

The hot melt glue layer 30 is a three-layer structure, comprising a first glue layer 32, a second glue layer 34 and an isolation layer 36 located between the first and second glue layers 32, 34. The two glue layers 32, 34 are respectively located on two sides of the isolation layer 36 to form upper and lower glue layers. The first and second glue layers 32, 34 are made of hot melt adhesive material, and the isolation layer 36 is preferably not made of hot melt adhesive material and has a melting point higher than that of the two glue layers 32, 34. The isolation layer 36 is used to block flowing of hot melt adhesive between the first glue layer 32 and the second glue layer 34. The hot melt glue layer 30 is adhered to the glutinous layer 14 with the first glue layer 32.

When the hot melt adhesive film 10 of FIG. 16 is used to heat press a graphic on a surface of an object, end consumers first cut out the graphic 40 from the hot melt glue layer 30, as shown in FIG. 17. The cut mark 42 of the graphic 40 cuts through/cuts off the hot melt glue layer 30. The graphic 40 can be texts, words, symbols, various patterns or a combination thereof, and can comprise a pattern portion and a word portion as shown in the graphic 40 of FIG. 14. At this time, the graphic 40 cut out from the hot melt glue layer 30 is a mirror image of a heat pressed graphic to be formed.

After the graphic 40 (mirror image) is cut out, waste materials other than the graphic 40 are torn off from the hot melt glue layer 30. FIG. 17 shows the hot melt adhesive film 10a and a hot melt glue layer 30a from which waste materials have been removed. The hot melt glue layer 30a has a shape of the graphic 40.

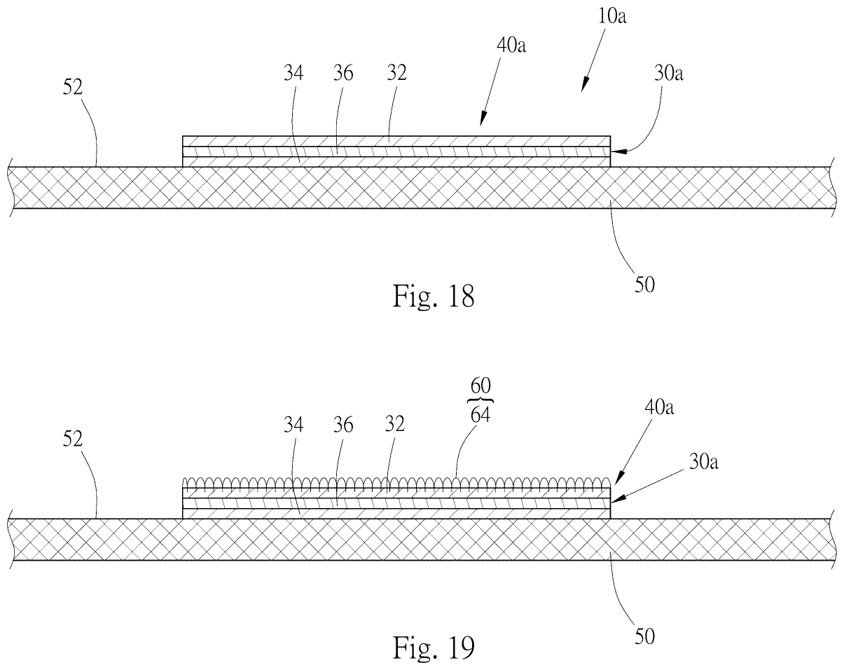

The hot melt glue layer 30a of FIG. 17 is heat pressed and adhered to a surface 52 of an object 50. After heat pressing is completed, the positioning layer 12 is torn off, leaving only the hot melt glue layer 30a constituting the graphic 40 adhered on the object 50, as shown in FIG. 18. At this time, the hot melt glue layer 30a is bonded to the heat pressed object 50 by the second glue layer 34; the graphic 40a is a positive image. A method of heat pressing the hot melt glue layer 30a on the surface 52 of the object 50 is the same as that shown in FIG. 5. During heat pressing, the first and second glue layers 32, 34 are separated by the isolation layer 36.

Then, a transfer sheet 60 is placed on the object 50, so that the transfer material 64 of the transfer sheet 60 contacts the first glue layer 32 of the hot melt glue layer 30a, and heat pressing is performed, so that the transfer material 64 of the transfer sheet 60 is adhered to the first glue layer 32 of the hot melt glue layer 30a. After heat pressing, the transfer sheet 60 is torn off, and the graphic 40a can be heat pressed and transferred onto the object 50. As shown in FIG. 19, a surface of the graphic 40a is formed with the transfer material 64.

The three-layer hot melt adhesive film 10 of FIG. 16 blocks flowing of the hot melt adhesive between upper and lower layers. Hot melt adhesives of the first glue layer 32 and the second glue layer 34 are independent and bonded to the heat pressed object 50 and the transfer material 64 of the transfer sheet 60 respectively. An adhesion of each of the glue layers 32, 34 can be precisely controlled so that a bonding effect between upper and lower surfaces of the hot melt adhesive film 10 and the object 50 and the transfer material 64 is highly stable. After all, when the heat pressed object 50 of the graphic 40 to be formed is a fabric, the fabric has fibers and gaps, and therefore an influence of heat pressing time and pressure may cause too little or too much hot melt adhesive to sink into the fabric. The second glue layer 34 of the hot melt glue layer 30 of the invention is capable of precisely controlling adhesion amount and adhesion depth of the hot melt adhesive and the fabric. Likewise, the first glue layer 32 of the hot melt glue layer 30 is capable of precisely controlling an adhesion amount of the hot melt adhesive to the transfer material 64. For example, when the transfer material 64 is fluff, the hot melt glue layer 30 can be bonded to the fluff with an optimal amount of hot melt adhesive. If the hot melt adhesive is too thick or an amount is too much, the fluff will be overly adhered with the hot melt adhesive to cause poor tactile impression; if the hot melt adhesive is too thin or an amount is too little, the fluff will fall off easily. Such drawbacks will not occur in the invention.

In addition, the first glue layer 32 and the second glue layer 34 can be made of hot melt adhesives of different materials, so that upper and lower glue layers of the hot melt glue layer 30 are capable of providing optimal adhesion effects to the object 50 and the transfer material 64 respectively. For example, when the graphic 40 is made on a surface of a fabric by heat pressing, the fabric can be made of natural fibers or artificial fibers, the artificial fibers can be nylon, polyester fibers, polypropylene fibers or glass fibers, and the transfer material 64 can be various materials such as bronzing, glitter, light reflective or fluff. Therefore, suitable hot melt adhesives can be selected for the first glue layer 32 and the second glue layer 34 according to different fabrics and transfer materials.

As can be known from the above description, the hot melt adhesive film of the invention enables end consumers to produce fine graphics of fluff, micro glass beads, luminous particles, bronzing materials or glitter on a surface of an object by DIY, thus solving the drawbacks of the conventional techniques in the prior art.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is:

1. A hot melt adhesive film comprising:
a positioning layer;
a glutinous layer; and
a hot melt glue layer made of a hot melt adhesive material, the hot melt glue layer being bonded to the positioning layer through the glutinous layer; an adhesion force between the hot melt glue layer and the glutinous layer being smaller than an adhesion force between the positioning layer and the glutinous layer.

2. The hot melt adhesive film as claimed in claim 1, wherein the hot melt adhesive film is provided for cutting out graphics, and the hot melt glue layer constituting the cut-out graphics is positioned on the positioning layer.

3. The hot melt adhesive film as claimed in claim 1, wherein the hot melt glue layer is in a form of one layer or a plurality of layers of hot melt adhesive.

4. The hot melt adhesive film as claimed in claim 1, wherein the hot melt glue layer has a first glue layer and a second glue layer disposed as upper and lower layers.

5. The hot melt adhesive film as claimed in claim 4, wherein the first glue layer and the second glue layer are hot melt adhesives of different materials.

6. The hot melt adhesive film as claimed in claim 1, wherein the hot melt glue layer has a first glue layer, a second glue layer and an isolation layer located between the first glue layer and the second glue layer, the first glue layer and the second glue layer are made of hot melt adhesive materials; the isolation layer separates a hot melt adhesive of the first glue layer from a hot melt adhesive of the second glue layer; and the first glue layer is bonded to the glutinous layer.

7. The hot melt glue layer as claimed in claim 6, wherein a melting point of the isolation layer is higher than melting points of the first glue layer and the second glue layer.

8. The hot melt adhesive film as claimed in claim 1, wherein a melting point of the position layer is higher than a melting point of the hot melt glue layer.

9. The hot melt adhesive film as claimed in claim 1, wherein the glutinous layer has release properties.

10. The hot melt adhesive film as claimed in claim 1, wherein the positioning layer is a plastic film or a paper.

11. The hot melt adhesive film as claimed in claim 1, wherein a material of the positioning layer is polyethylene terephthalate (PET), polyvinyl chloride (PVC) or polypropylene (PP).

12. The hot melt adhesive film as claimed in claim 1, wherein a material of the hot melt adhesive of the hot melt glue layer is polyolefin (PO), polyurethane (PU), thermoplastic polyurethane (TPU), polyamide (PA), polyether sulfone (PES), polyethylene (PE), ethylene vinyl acetate (EVA) or rubber based material (thermoplastic rubber (TPR)/rubber).
